(19) United States
(12) Patent Application Publication
(10) Pub. No.: US 2010/0089065 A1
(43) Pub. Date: Apr. 15, 2010

(54) FUEL DELIVERY SYSTEM FOR A TURBINE ENGINE

(76) Inventor: Richard S. Tuthill, Bolton, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/251,503

(22) Filed: Oct. 15, 2008

(51) Int. Cl. F02C 7/22; F23R 3/28

(52) U.S. Cl. 60/737; 60/740; 60/746; 239/398

(57) ABSTRACT

A fuel delivery system for a turbine engine has at least one fuel injector having an upstream orifice arrangement that produces a first pressure drop of flowing fuel and a downstream orifice arrangement that produces a second pressure drop of the flowing fuel. The upstream orifice arrangement or the downstream orifice arrangement includes a noncylindrical orifice.

### BACKGROUND OF THE INVENTION

The present invention relates to a fuel delivery system for a gas turbine engine and, more particularly, to an emission reducing fuel injector of the fuel delivery system.

Environmental concerns and standards, generally enforced by increasingly stringent government regulations, require relatively low exhaust emission levels from turbine engines such as the gas type. To assist in obtaining very low emission levels, a lean premix combustion process is commonly utilized. In this process, the fuel and air are mixed prior to combustion and burned close to the fuel-lean extinction limit. This premix process provides a sufficiently lean fuel-air concentration ratio in the reaction zone so that emission levels for nitrogen oxide generation are minimized upon combustion.

In a lean premix system, fuel and air are mixed thoroughly in a premix passage prior to combustion. The requirements for very low NOx emissions demand fuel/air concentration ratios that are close to the concentration ratio at which reactions are no longer self supporting (the weak limit) and the flame extinguishes. As a result, small variations or perturbations in fuel-air ratio within the combustor can produce large transient temperature variations and associated pressure disturbances. When pressure disturbances occur in a combustor chamber and propagate upstream into the premix passage, local mass flow rates for the fuel and air correspondingly may change differently and out of phase relative to each other.

The reason for this is that a transient change in pressure within the premixer will add to or subtract from the inertia forces of the two fluids as manifested by their momentum fluxes (the product of their fluid density times the square of their velocity magnitude in the direction perpendicular to their respective passage cross section at the point of fuel injection). Thus the effect on each flow will be unequal and out of phase if their steady state momentum fluxes are unequal, resulting in a fuel-air concentration ratio fluctuation that is convected down the premix passage to the combustion chamber. This concentration fluctuation in turn results in fluctuation of gas temperatures in the combustion chamber that in turn gives rise to further pressure fluctuations in an amplification cycle. Further amplification of this cycle can occur at frequencies close to the acoustic resonant frequencies of the combustion chamber that encloses the combustion process. Unfortunately, high pressure oscillations in the combustion chamber can create high vibratory stress upon the combustion chamber components causing premature failure of the components that can adversely affect the gas turbine as a whole.

One known partial solution in the prior art utilizes a two-stage metering fuel injector for the combustor. The fuel injector has an upstream fuel orifice that provides a high pressure drop and a downstream fuel orifice that provides a low pressure drop. The downstream orifice is sized such that a momentum flux ratio of fuel to air at the point of premixing (i.e. the downstream orifice) is approximately 1. While this configuration may be a partial improvement over single stage fuel injector metering, high pressure oscillations are still widely observed within the combustion chambers equipped with this feature in their fuel injectors.

### SUMMARY OF THE INVENTION

A fuel injector of a fuel delivery system for a gas turbine engine of the present invention reduces emissions by premixing fuel and air in a fuel lean concentration near the weak extinction limit prior to combustion, and by providing uniformity of a fuel air mixture within the combustion system. The system achieves this uniformity by ensuring that any pressure disturbances within the combustion chamber affect the flow of fuel and air substantially equally.

A fuel injector, preferably for a turbine engine, includes a body including an upstream orifice arrangement that generally creates a first pressure drop and a downstream orifice arrangement that generally creates a second pressure drop. The upstream orifice arrangement or the downstream orifice arrangement includes a noncylindrical orifice.

One embodiment of the fuel injector comprises a central axis of the body, a plurality of fuel orifices of the upstream orifice arrangement spaced circumferentially about the central axis, and a plurality of discharge orifices of the downstream orifice arrangement spaced circumferentially about the central axis. An effective cross-sectional flow area of the upstream orifice arrangement is greater than or substantially equal to an effective cross-sectional flow area of the downstream orifice.

### BRIEF DESCRIPTION OF THE DRAWINGS

The various features and advantages of this invention will become apparent to those skilled in the art from the following detailed description of an example embodiment. The drawings that accompany the detailed description can be briefly described as follows.

FIG. 1 is a schematic view of a combustor for a gas turbine engine embodying the present invention.

FIG. 2 is a cross-section of a fuel injector for the combustor.

FIG. 3 is a cross-section taken at line B-B as indicated in FIG. 2.

FIG. 3A is a cross-section of an alternative embodiment taken at line B-B as indicated in FIG. 2.

FIG. 3B is a cross-section of an alternative embodiment taken at line B-B as indicated in FIG. 2.

FIG. 4 is a cross-section taken at line C-C as indicated in FIG. 2.

FIG. 5 is a close-up cross-section of an alternative fuel injector for a combustor.

FIG. 6 is a cross-section taken at line D-D as indicated in FIG. 5.

### DETAILED DESCRIPTION OF THE PREFERRED EMBODIMENT

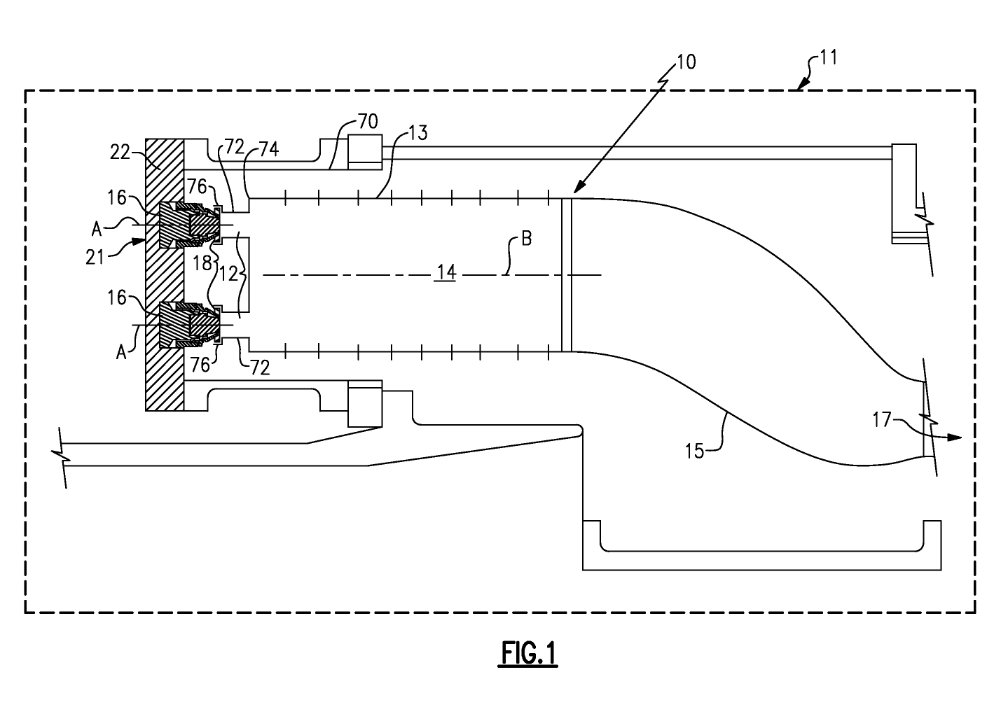

In FIG. 1 of the present invention, a turbine engine 11 that may be of a gas type has a plurality of circumferentially spaced combustors 10 that each extend generally along respective centerlines B. Each combustor 10 has an encasement 70 that generally supports a fuel delivery system 21 and houses a tubular structure or liner 13 and a transition duct 15 of the combustor 10. The fuel delivery system 21 delivers a controlled fuel flow to fuel injectors 16 which inject the fuel into a premixing passage 12. The fuel injectors 16 also provide air inlet passages 18 which admit air into the premix passages 12 where the air and fuel premix before passing through an end flange 74 of the liner 13 and to a combustion chamber 14 defined by the liner 13 where the fuel-air mixture is burned. The resulting hot products and various gases flow downstream along centerline B in the direction of the transition duct 15, through the transition duct and into the turbine section of the engine in the direction indicated by arrow 17. Ultimately, the products of combustion and hot gases generally expand in the turbine section and thus engine 11 extracts mechanical shaft work from the flow of these gases.

A substantially cylindrical end cover or fuel manifold 22 of the delivery system 21 operatively seats and supports a plurality of fuel injectors 16 that dispense fuel into respective premix passages 12 each defined by a respective sleeve 72. Each fuel injector 16 and respective sleeve 72 is disposed concentrically about respective axis A substantially positioned perpendicular to the manifold 22 and flange 74 of the liner 13. Each sleeve 72 (two shown) is engaged to and projects upstream from the flange 74 and to a distal end portion 76. Each fuel injector 16 projects into the respective distal end portion 76 of the sleeve 72.

It should be understood that FIG. 1 is for illustrative purposes only and is not a limitation on the disclosed example. For example, the premix passages 12 could be separate from the liner 13 and could instead provide a slip-fit engagement so that the pre-mixed fuel-air mixture can flow into the combustion chamber 14. Also, in another example, the premix passages 12 could be attached to, or formed as part of, the fuel injectors 16.

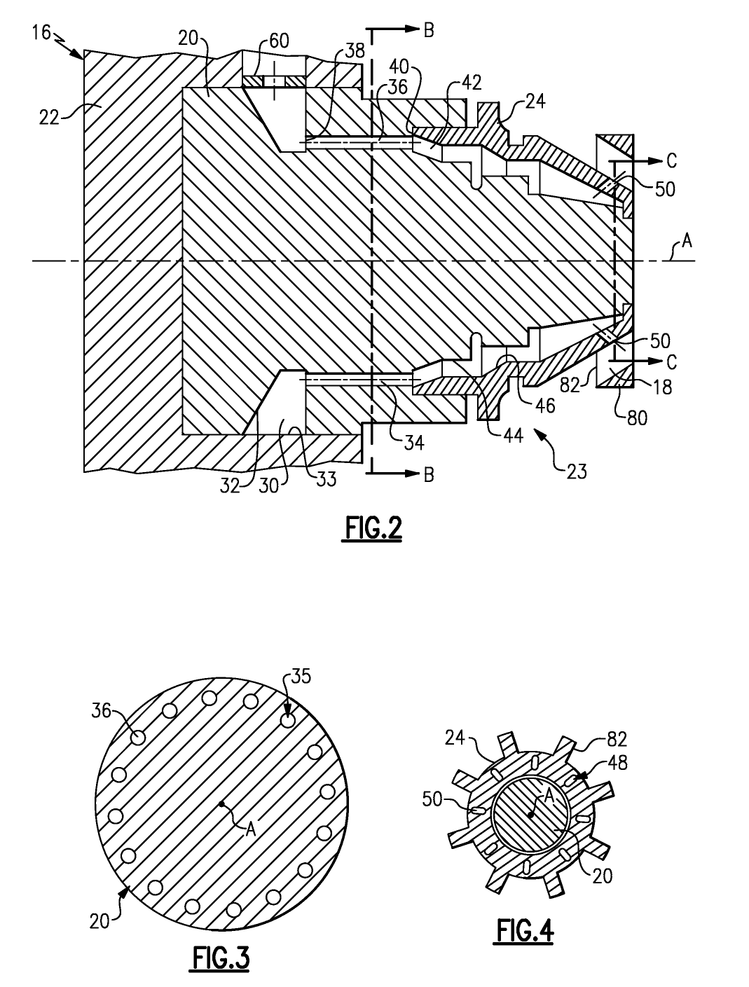

To prevent dynamic pressure fluctuations of the prior art from affecting the fuel and air premixer flow rates, unequally and out of phase, and thus amplifying the pressure disturbances, the characteristics of the fuel injectors 16 are matched as closely as possible to that of the passages that supply air to the premixer 12. Referring to FIG. 2, the fuel injector 16 includes a body 23 that has a central core 20 disposed substantially concentric to axis A and seated sealably to an end cover manifold 22 of the delivery system 21 for receiving fuel. The injector central core 20 projects downstream from the end cover 22 to engage and support a distal end casing or nozzle 24 of the injector 16. It should be understood that while the core 20 and nozzle 24 of the injector 16 are described as separate components of the body 23, a single and unified body may also be used, or additional could be used as needed.

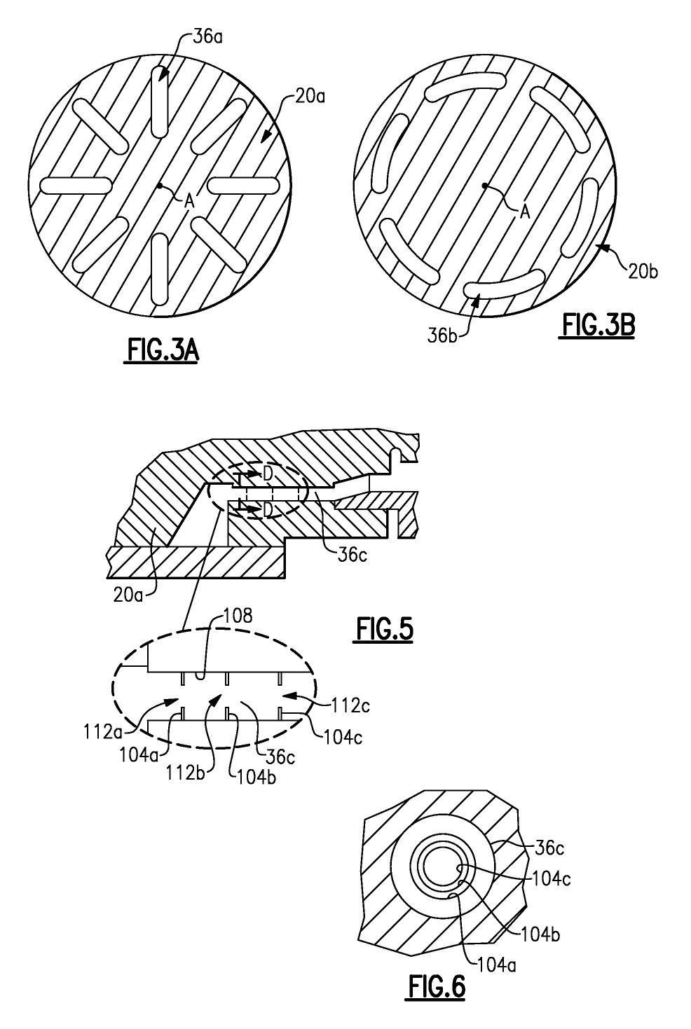

Referring now to FIG. 3 with continuing reference to FIG. 2, an upstream fuel plenum 30 may be substantially annular or ring-like in shape and is generally defined radially between the end cover or manifold 22 of the delivery system 21 and the core 20 of the injector 16. The fuel plenum 30 is bounded at least by an outer surface 32 of the core 20 and a cylindrical inner surface 34 of the end cover 22. An orifice arrangement 35 is established within the core 20. The example orifice arrangement 35 includes a plurality of axially extending fuel orifices 36 that are formed within the core 20 and are circumferentially spaced apart from each other about the central axis A. In one example, the fuel orifices 36 are fuel bores.

The fuel orifices 36 extend in an axial direction and are generally parallel to the central axis A. Each respective upstream end 38 of the fuel orifices 36 is in direct fluid communication with the annular fuel plenum 30, and an opposite downstream end 40 of each fuel orifices 36 is in direct fluid communication with an annular chamber 42. The annular chamber 42 is formed between an outer surface 44 of the core 20 and an inner surface 46 of the casing or nozzle 24.

Another orifice arrangement 48 is established within the nozzle 24. The example orifice arrangement 48 includes a plurality of discharge orifices 50 are formed within the nozzle 24. In one example, the discharge orifices 50 are discharge bores.

The discharge orifices 50 are spaced circumferentially apart from each other about the central axis A (FIG. 4). The discharge orifices 50 are obliquely orientated relative to the central axis A to facilitate mixing of the fuel and air. Fuel flows from a fuel supply (not shown), through the end cover manifold 22, to the fuel plenum 30, through the fuel orifices 36, into the annular chamber 42, and then into the discharge orifices 50 where the fuel exits into the airflow passing through the annular air inlet 18 and then through the premix passage 12.

The plurality of fuel orifices 36 cooperate to provide an upstream metering orifice that defines a first pressure drop, i.e. measured across end 38 and end 40, and the plurality of discharge orifices 50 cooperate to provide a downstream fuel orifice that defines a second pressure drop. The metering and discharge orifices 36, 50 are sized such that the first pressure drop is less than or substantially equal to the second pressure drop. To accomplish this differential pressure relationship, the effective cross-sectional flow area of the sum of the fuel orifices 36 is greater than or substantially equal to the effective cross-sectional flow area of the sum of the discharge orifices 50 (as illustrated in FIGS. 3 and 4).

The fuel injector 16 includes an annular air inlet 18 of fuel nozzle 24 defined by an outer shroud 80 supported by radial vanes or struts 82 (that may or may not impart swirl) to provide an air entry and initial fuel mixing point. The momentum flux of fuel through discharge orifices 50 closely matches the momentum flux of air through the air inlet passage 18. By reducing the pressure drop of the upstream fuel orifices or fuel orifices 36 to a level that is substantially equal to or less than the downstream discharge orifices or discharge orifices 50, makes fuel response to pressure disturbances mimic more closely to that of air. In this manner, variations in fuel-air mixture ratio can be minimized, which in turn minimizes the possibility of unwanted thermo-acoustic coupling that can cause vibratory pressure oscillation and potential damage to turbine components.

It should be understood that FIG. 2 is for illustrative purposes only and is not a limitation on the disclosed example. For example, the air inlet passage 18 could be separate from the fuel nozzle 24 and could instead be formed or attached to the premix passage 12 defined by sleeve 72 and distal portion 76.

Referring to FIGS. 3A and 3B, other examples of the fuel orifices include cores 20a and 20b having orifices 36a and 36b with other noncylindrical cross-sectional profiles. The orifices 30a have a noncylindrical cross-sectional profile that extends radially relative to the axis A. The orifices 30b have noncylindrical cross-sectional profile extending circumferentially relative to the axis A. The example orifices 30a and 30b are axisymmetrically distributed about the axis A.

In one example, a single orifice 60 is positioned upstream of and is in fluid communication with the fuel plenum 30 to ensure uniformity of flow between fuel injectors 16 that are manifolded together via end cover 22. In the example shown, the orifice 60 is formed within or supported by the end cover manifold 22.

The fuel orifice 60, in one example, provides another metering orifice that defines a third pressure drop. That is, the pressure outside the fuel plenum 30 is greater than the pressure inside the plenum 30.

The fuel injector 16 achieves a fuel/air momentum flux ratio of approximately one at the desired operating condition in inlet 18 of premix passage 12 by appropriately sizing the downstream orifice, i.e. discharge orifices 50. The upstream orifice, i.e. fuel orifices 36, is sized to mimic the impedance to the airflow upstream of the inlet 18 and is application-specific. In all practical cases the upstream pressure drop will be substantially equal or lower than the downstream pressure drop.

It should be understood that while a plurality of fuel orifices 36 and a plurality of discharge orifices 50 are shown, only a single fuel orifice 36 and/or a single discharge orifice 50 may be needed. Further, a single fuel orifice 36 could be used in combination with a plurality of discharge orifices 50, or a plurality of fuel orifices 36 could be used in combination with a single discharge orifice 50.

Referring to FIGS. 5 and 6, a core 20a includes a plurality of axially extending fuel orifices 36c. The orifices 36c are formed within the core 20a. The fuel orifices 36c extend in an axial direction and are generally parallel to a central axis A (FIG. 2) of the core 20a.

Each of the orifices 36c includes a plurality of baffles 104a-104c extending inwardly from a wall 108 of the orifices 36c. Each of the baffles 104a-104c establishes an opening 112a-112c for communicating fuel through the orifices 36a. Notably, the openings 112a-112c have a smaller diameter than the other portions of the fuel orifices 36c. Further, the opening 104a is larger than the opening 104b, which is larger than the opening 104c. The progressively smaller openings 104a-104c each provide an incremental pressure drop through the orifices 36c. Thus each of the baffles 104a-104c produces an incremental pressure drop.

Features of the disclosed examples include a cross-sectional flow area of an upstream orifice arrangement that is larger than or substantially equal to a cross-sectional flow area of a downstream orifice arrangement. This difference is important because the airflow entering the premixer of prior art lean premixed combustion system designs does not pass through an upstream orifice that provides a pressure drop higher than the dynamic head arising from the momentum flux of air in the premixer. (The reason for this is that high airflow pressure drop severely penalizes the thermodynamic efficiency of the engine.) Thus, by making the upstream orifice arrangement in the fuel injector larger than or substantially equal to the downstream orifice arrangement of the fuel injector, the upstream orifice pressure drop is lower than or substantially equal to the downstream pressure drop and this allows the fuel flow to respond to a pressure oscillation in the premixer in a manner that much more closely mimics that of the air.

The figures are for illustrative purposes only and are not a limitation on the disclosed examples. Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

1.-20. (canceled)

21. A fuel injector comprising:
a body including an upstream orifice arrangement constructed and arranged to produce a first pressure drop and a downstream orifice arrangement in fluid communication with said upstream orifice arrangement and constructed and arranged to produce a second pressure drop, wherein at least one of said upstream orifice arrangement or said downstream orifice arrangement includes a noncylindrical orifice.

22. The fuel injector according to claim 21 wherein orifices of said upstream orifice arrangement have a noncircular radial cross-section.

23. The fuel injector according to claim 21 comprising: an annular chamber formed within said body and positioned axially between said upstream orifice arrangement and said downstream orifice arrangement.

24. The fuel injector according to claim 23 wherein said upstream orifice arrangement is in direct fluid communication with said annular chamber and wherein said annular chamber is in direct fluid communication with said downstream orifice arrangement.

25. The fuel injector according to claim 21 wherein each orifice of said upstream orifice arrangement has a plurality of baffles axially spaced from one another and with respect to an axis A, said plurality of baffles configured to provide a plurality of incremental pressure drops through each upstream orifice.

26. The fuel injector according to claim 21 wherein said upstream orifice arrangement comprises a plurality of individual fuel orifices arranged axisymmetrically about an axis established by said body.

27. The fuel injector according to claim 21 comprising: a central axis of said body; a plurality of fuel orifices of said upstream orifice arrangement spaced circumferentially about said central axis; and a plurality of individual discharge orifices of said downstream orifice arrangement spaced circumferentially about said central axis.

28. The fuel injector according to claim 27 comprising: a central core of said body disposed substantially concentric to said central axis and including said individual fuel orifices; and a nozzle of said body disposed and engaged concentrically about said core and which includes said discharge orifices.

29. The fuel injector according to claim 21 comprising: a central axis of said body; a central core of said body disposed substantially concentric to said central axis; and wherein said upstream orifice arrangement extends axially through said core.

30. The fuel injector according to claim 21 wherein an effective cross-sectional flow area of said upstream orifice arrangement is greater than or substantially equal to an effective cross-sectional flow area of said downstream orifice arrangement.

31. The fuel injector according to claim 21 further comprising:
an air inlet passage defined at least in part by said body and constructed and arranged to communicate with said downstream orifice arrangement; and
wherein a fuel momentum flux through said downstream orifice arrangement is substantially equal to an air momentum flux through said air inlet passage.

32. The fuel injector according to claim 21 wherein said first pressure drop is less than or substantially equal to said second pressure drop.

33. A turbine engine comprising:
a combustor; and
a fuel delivery system including at least one fuel injector having a body including an upstream orifice arrangement constructed and arranged to produce a first pressure drop of fuel and a downstream orifice arrangement constructed and arranged to produce a second pressure drop of said fuel, wherein at least one of said upstream orifice arrangement or said downstream orifice arrangement includes a noncylindrical orifice.

34. The turbine engine according to claim 33 comprising: a central axis of said body; a plurality of fuel orifices of said upstream orifice arrangement spaced circumferentially about said central axis; and a plurality of discharge orifices of said downstream orifice arrangement spaced circumferentially about said central axis.

35. The turbine engine according to claim 33 comprising: a plurality of baffles disposed in said upstream orifice arrangement, said downstream orifice arrangement, or both, wherein said plurality of baffles are configured to provide an incremental pressure drop of fuel through said upstream orifice arrangement, said downstream orifice arrangement, or both.

36. The turbine engine according to claim 33 wherein said first pressure drop is less than or substantially equal to said second pressure drop.

37. The turbine engine according to claim 33 comprising: a central axis of said body; a central core of said body disposed substantially concentric to said central axis; an end cover that sealably seats said central core; and an upstream annular fuel plenum defined radially between said end cover and said core.

38. The turbine engine according to claim 37 comprising: a plenum orifice upstream of and in fluid communication with said fuel plenum, wherein said plenum orifice is constructed and arranged to provide a third pressure drop of fuel.

39. A fuel system for a turbine engine comprising:
a fuel injector having,
a body including an upstream orifice arrangement constructed and arranged to produce a first pressure drop and a downstream orifice arrangement in fluid communication with said upstream orifice arrangement and constructed and arranged to produce a second pressure drop, and
wherein at least one of said upstream orifice arrangement or said downstream orifice arrangement includes a noncylindrical orifice;
a premix passage defined at least in part by said body and constructed and arranged to communicate with said downstream orifice arrangement; and
wherein a fuel momentum flux through said downstream orifice arrangement is substantially equal to an air momentum flux through said air inlet passage and proximate to said downstream orifice arrangement.

40. The fuel system set forth in claim 39 comprising:
a plurality of fuel injectors with said fuel injector being one of said plurality of fuel injectors, wherein each fuel injector has a plenum orifice constructed and arranged to communicate directly with an annular fuel plenum.
